(19) United States
(12) Patent Application Publication
(10) Pub. No.: US 2009/0005090 A1
(43) Pub. Date: Jan. 1, 2009

(54) Method for Providing Global Short Message Service

(76) Inventors: Sung-Ryong Hong, Gyeonggi-do (KR); Ju-Tae Kim, Gyeonggi-do (KR)

Correspondence Address: STAAS & HALSEY LLP, SUITE 700, 1201 NEW YORK AVENUE, N.W., WASHINGTON, DC, 20005, US

(21) Appl. No.: 12/224,210

(22) PCT Filed: Mar. 12, 2007
(86) PCT No.: PCT/KR2007/001197

§ 371 Date: Aug. 21, 2008

(30) Foreign Application Priority Data
Mar. 15, 2006 (KR) 10-2006-0023888

(51) Int. Cl. H04Q 7/20; G06F 17/20

(52) U.S. Cl. 455/466; 704/8

(57) ABSTRACT

The present invention relates to a method of transferring a SMS between countries using different kinds of languages, that is, Mobile Stations (MSs) using different kinds of languages, and a computer-readable recording medium for implementing the SMS transfer method. The present invention provides a method of writing/transmitting a SMS by selecting and inputting a specific one of several foreign languages, which can be input in a receive MS, to transfer a SMS written in a foreign language from a transmit MS using a first language as a main language to the receive MS using a foreign language as a main language through a P2P network in which SMS nodes are independently connected on a country basis. The method includes \textcircled{1} a foreign language character input program installation step, \textcircled{2} a message transmission step, \textcircled{3} a global transmission step and \textcircled{4} a message reception step. According to the present invention, a global SMS can be transmitted conveniently and economically between countries using different kinds of languages, which was difficult due to the difference in a language structure in the prior art.

### TECHNICAL FIELD

The present invention relates to a method of transmitting a Short Message Service (hereinafter, referred to as “SMS” between countries using different languages that is, between Mobile Stations (MSs) using different kinds of languages, and a computer-readable recording medium for realizing the SMS transfer method, and more particularly, to a method for providing global SMS and a computer-readable recording medium for realizing the SMS transfer method, in which a difficulty in providing global SMS due to a difference in the language structure can be relieved.

### BACKGROUND ART

With a rapid development of various wired/wireless communication technologies and globalization of economic and cultural activities, there is an increasing need to transmit a SMS written in a foreign language to an overseas mobile phone or e-mail abruptly. In the case where a PC terminal is used, it is not so difficult to write and send a SMS since there are various types of foreign language input devices (input programs). However, in the case of a transmission terminal, such as portable and small-sized communication equipment including mobile phones, it is very difficult to write and send a SMS in languages other than a transmission country language (and the English language) due to its physical limits (of standards) and a limited main use language on a product-output-region basis.

The utilization of a SMS within a country has been rapidly increased since the SMS is cheaper than voice communication and a message can be transmitted accurately. However, for inter-country SMS connection, it is required that respective country s mobile communication companies cooperate with each other, and devices and programs suitable for an inter-country language structure be prepared in advance for interface cooperation. Accordingly, there are problems in that the utilization of a global SMS is very low compared with a local SMS, and the fee is expensive due to the infra construction and the maintenance cost.

To solve the problems, several techniques have been disclosed.

Korean Patent Application No. 10-2003-004910 (entitled “Global SMS”) discloses a SMS providing method in which an Internet site where a SMS is possible is opened at the locale, mobile communication companies cooperate with each other, a global SMS transmission route is secured by connecting to a global site representing it, and a SMS font of each country's language is downloaded, if needed, so that the SMS can be used on a language basis. However, according to this technique, it is difficult to be actually applied and a high cost is required because a local Internet site and an integrated website must be opened at a (all) foreign country and (all) overseas mobile communication companies must cooperate with each other.

Korean Patent Application No. 10-2003-0076297 (entitled “Method for Providing Global SMS”) discloses \textcircled{1} a case in which a user sends a SMS from an A country to a wireless terminal (it refers to a mobile phone) of a B-country counterpart by using a wired terminal (it refers to a PC), and \textcircled{2} a case in which a SMS is sent from an A-country mobile communication company to a wireless terminal (it refers to a mobile phone) of a B-country counterpart that allows for global roaming service through an A-country wireless terminal. However, the method \textcircled{2} has the spatial limits in selecting terminals (that is, it cannot be used by using mobile phones) since the SMS is sent to a foreign country through the PC. The method \textcircled{2} is restricted to a receiver side because it is on the condition that the roaming service is allowed with respect to the mobile phone used in the A-country.

Korean Patent Application No. 10-2003-0076301 (entitled “Mobil Text Message Delivery System Using Image Conversion Method”) relates to a method in which if a user who wants to send a text message to other countries with different languages sends the text message, a message conversion system converts the message into a picture file and sends it to the last recipient via Multimedia Message Service (MMS), or sends an URL through the message can be downloaded using URL LINK SMS. This method is limited to the transmission of A-country characters from an A-country to the mobile phone of a B-country. This method has problems, such as additional equipment, additional time and an increased file capacity, in the step of converting to a picture file, and cannot be employed when a receiving-country mobile communication company or a receiving mobile phone does not support MMS.

Korean Patent Application No. 10-2004-0045927 (entitled “A Character-Image Input System of Portable Telephoned a Method Using Thereof”) discloses a method of writing a document by repeating a process of, if a unicode input server presents a sender terminal with foreign character graphics and a specified number corresponding to them, a user inputs/sends the number of a keypad corresponding to a desired character, and the server receives the key number and converts texts into an image. However, the method is disadvantageous in that communication between the mobile phone and the server must be repeated or maintained in order to write a sentence, and the sender terminal cannot confirm the contents of an input document even if the last document is completed. Accordingly, the method is not meaningful as a foreign language input method for SMS.

### DISCLOSURE OF THE INVENTION

### Technical Problem

Accordingly, the present invention has been made in an effort to solve the above problems occurring in the prior art, and an object of the present invention is to provide a method in which foreign language characters can be conveniently input using a mobile phone and a SMS written in a foreign language can be sent to foreign countries through simple steps without any need for complicated infra.

Another object of the present invention is to provide a computer-readable recording medium in which a program for SMS transmission between MSs using different languages is recorded.

### Technical Solution

In order to clarify the construction of the present invention and help understanding of the present invention, the terms used herein are defined as follows.

The term “External Short Message Entity (ESME)” refers to respective nodes participating in a SMS transmission route and collectively refers to all nodes, such as SMSC, MS(mobile station) and SMS gateway.

The term “Protocol Data Unit (PDU)” refers to data exchanged between respective nodes, and is also generally referred to as a “packet”.

The term “Short Message Peer to Peer Protocol (SMPP)” refers to an international SMS transmission standard protocol defined in SMS Forum (http://smsforum.net), and is generally an Application Layer protocol existing on TCP or X.25 protocol.

The term “Short Message Service Center (SMSC)” is an abbreviation of a SMS center. Each SMSC includes a server and a client. The server and the client are connected via P2P session. The client requests the server to send a SMS. In this case, upon a transmission request, communication between the client and the server is performed using a protocol, such as the SMPP.

A Peer-to-Peer (P2P) network refers to a network in which only one other node is connected to one node participating a network. That is, this network is a network in which two nodes are directly connected one to one and communicate with each other.

The term “Mobile Station (MS)” refers to a movable SMS transmit/receive medium. Representative MSs include a mobile phone, a PDA, etc. A portable terminal, a wireless terminal and so on to which the method according to the present invention is applied are referred to as a “MS”.

The term “Multimedia Message Service (MMS)” refers to a service in which multimedia data can be sent and received.

The term “Enhanced Messaging Service (EMS)” refers to a messaging service in which texts (font, effects and colors), animation, images, icons, sound, ring sound, etc. of a specific form can be transferred.

The term “callback URL SMS” refers to a service in which a SMS can be sent with an address of a Wireless Application Protocol (WAP) page being attached thereto, and is a service generally used for advertising SMS.

The term “Phone Mail” refers to a service in which e-mail can be viewed in a mobile phone with a mail client being mounted in the mobile phone. This service has been used in Japan.

The term “Simple Message Transfer Protocol (SMTP)” refers to a protocol used in e-mail transmission.

The term “Wireless Application Protocol (WAP)” refers to a protocol employing the HTTP service used in the MS including the mobile phone. In Korea, the WAP service is provided by NATE of SKT, Magic N of KTF and the forth.

(1) To achieve the above objects, the present invention provides a method of writing and sending a SMS by selecting and inputting a specific one of several foreign languages that can be input in a transmit MS to transfer a SMS written in a foreign language from the transmit MS using the first language as a main language to a receive MS using a foreign language as a main language through a P2P network in which SMS nodes are independently connected on a country basis, the method including \textcircled{1} a foreign language character input program installation step, \textcircled{2} a message transmission step, \textcircled{3} a global transmission step and \textcircled{4} a message reception step.

In the present invention, (A) the foreign language character input program installation step is a step of allowing the transmit MS to gain access to an operating server for performing the method of the present invention, in which a language DB on a foreign-language basis, functions and a control program are stored, download the language DB, the functions and the control program, and have the language DB, the functions and the control program installed therein. It is enough to perform this step only once except for update. Thus, when a foreign language character input program has already been installed at the transmit MS (it can be installed upon MS fabrication or could had been installed when being used in the past), this step can be omitted.

The language DB on a foreign-language basis includes Input Automata, a phonemic font and codeset information with respect to an individual foreign language. The functions and the control program preferably include a key input API, a graphic API and a network API with respect to each foreign language. In this case, the above APIs can be APIs provided in a virtual machine (VM) of a MS or an Operating System (OS). Hereinafter, this is true in the present invention.

The Input Automata with respect to each foreign language serves to process combination rules of phonemic characters depending on a language. For example, in the case of the Latin language, if alphabets are sequentially input, characters are input. In the case of Asian languages (the Chinese language, the Korean language, the Japanese language, the Hindi language, Persian, the Arabian language, the Urdu language and so on), characters are input in such a manner that input phonemic alphabets are combined according to specific rules (an example of the Korean language (Hanguel): [symbol] + [symbol] + [symbol] → [symbol] . Accordingly, the Input Automata is an engine for combining languages input according to the rules.

The phonemic font with respect to each foreign language is a font (or a constituting part of the font) for outputting a foreign language phonemic (for instance, in the case of the Latin-based language, alphabets, and in the case of Hanguel, consonants and vowels or a disjointed common element of them) on a screen. Since most mobile phones support the fonts of the vernacular and the English language, the phonemic font is a font for supporting languages not supported in the mobile phones. To minimize the size of the program, it is preferred that language-based phonemic fonts are compressed and built in. In the case of a terminal in which the phonemic fonts cannot be built in due to the limited memory, etc., a method of downloading the phonemic fonts from the operating server, and deleting them after use can be used. This method can be omitted in mobile phones having unicode fonts built in.

Meanwhile, a codeset (for example, KSC-5601 for the Korean language, EUC-JP or Shift-JIS for the Japanese language, GB18030, HZ for the Chinese language, etc.) with respect to the vernacular characters is used in most mobile phones. Therefore, for example, in the case where character information encoded according to the Korean codeset is sent to a Japan mobile phone, the mobile phone decodes the received character information according to the Japanese language codeset, so that given not-understanding character strings are output. Accordingly, in the present invention, a unicode transmission protocol layer that is operated with reference to codeset information, which is encoded in response to the vernacular character on a foreign-language basis, can be used. In the case of a mobile phone supporting unicode transmission, the protocol layer can be omitted.

In the case of the Korean language, the Latin language, etc., the input of characters is completed if input letters are sequentially output or combined. However, for instance, Chinese character-based languages must be input in such a way that after alphabets, Hanguel or [symbol] [symbol] is input, the corresponding Chinese character is selected. Accordingly, it is preferred that conversion information about Chinese character input as well as Input Automata, a phonemic font and codeset information with respect to each foreign language be stored in the language DB.

According to the present invention, in the foreign language character input program, the key input API, the graphic API and the network API with respect to each foreign language are utilized as a VM of a terminal or an OS.

A conceptual view of a hierarchical structure in which the language DB on a foreign-language basis, including the Input Automata, the phonemic font and the codeset information, the key input API, the graphic API and the network API with respect to each foreign language, and the unicode transmission protocol are represented is illustrated in FIG. 1.

In the present invention, (B) the message transmission step is a step of allowing a sender-side user to input and send foreign language character information. The user recognizes that SMS information written in a foreign language is directly sent to a counterpart receive MS, but the SMS information is substantially sent through the operating server. In other words, if the transmit MS executes the foreign language character input program, selects a foreign language to be input, inputs a message with respect to a selected foreign language and then “send” a text message with a receive MS number (including a country code) being attached thereto, the message and the receive MS number information are sent to the operating server. At this time, before they are “Sent”, the input message is converted into selected foreign language codeset information.

In the present invention, (C) the global transmission step is a step of transferring the text message and the receive MS number information to a receiving-country mobile communication company. The operating server that has received the text message and the receive MS number transmits the text message and the receive MS number to a receive country SMS center by referring to the receive MS number.

A SMS transmission protocol includes a country standard and an international standard. If the SMPP having the international standard is used, codeset information (for example, in the case of Hanguel, 0 0 0 0 1 1 1 0=0×0E) of each SMS language is stored in a packet regarding SMS transmission, that is, a data_coding field, which is defined within deliver_sm, and submit_sm PDU.

However, in reality, most countries adopt an individual country standard suitable for its own nation's language system not the international standard so that a SMS is operated in accordance with the language system. For example, in the case of Korea, a standard defined in Korea Wireless Internet Standard Forum (KWISF) is used. The standard supports only Hanguel. Since it is expected that each country standard deals with only the vernacular, a language-related field, such as data_coding, is not defined unlike the SMPP, that is, the international standard. In the present invention, the foreign language codeset information complies with an individual foreign language-used country-based standard.

Meanwhile, the nodes that send a SMS, such as SMSC and ESME, are connected via the P2P network. It means that a movement path of additional SMS information exists on a language or country basis. As most of SMS is written based on an individual country standard (that is, since there is no codeset information), a SMS sent to a receive country is interpreted as being written according to the receiving-country country standard. Accordingly, if a SMS has been written according to the receiving-country country standard although there is no codeset information about a receiving-country language, it can be interpreted using the receiving-country language.

In the present invention, (D) the message reception step is a step of transferring the text message to the receive MS through a wired/wireless transmission path. In this step, a SMS represented in a foreign language is displayed on the receive MS by using the foreign language.

Through the above respective steps, a user can selectively input a desired one of many foreign language candidates. Meanwhile, the foreign language character input program of the invention, which allows a plurality of foreign languages to be selectively input, has Input Automata, a phonemic font, codeset information, functions and a control program with respect to each of a plurality of foreign languages, thereby has significantly large capacity. Accordingly, it is efficient that a user who mainly uses a specific foreign language not a plurality of foreign languages mounts a system, which can input only a corresponding foreign language, in a mobile phone.

(2) Another embodiment of the present invention for this purpose provides a method of inputting a foreign language since the foreign language to be input fixedly is decided in advance and writing/sending a SMS. That is, the present invention relates to a SMS transfer method between MSs using different languages, including \textcircled{1} a second language character input program installation step, \textcircled{2} a message transmission step, \textcircled{3} a global transmission step and \textcircled{4} a message reception step to transfer a SMS written in a foreign language from a transmit MS using a first language as a main language to a receive MS using a foreign language as a main language through a P2P network in which SMS nodes are independently connected on a country basis.

The present invention (2) has the same operating method and procedure as the invention (1) except that the language DB on a foreign-language basis includes Input Automata, a phonemic font and codeset information with respect to the second language, and the functions and the control program include a key input API, a graphic API and a network.

(3) Furthermore, the present invention relates to a computer-readable recording medium in which a program for implementing functions and for SMS transfer between MSs using different kinds of languages is recorded, the functions including a function of displaying Input Automata and a phonemic font with respect to a selected language and receiving a SMS in a receiving-country language; a function of converting the input SMS to phonemic font information of a receiving-country language; a function of receiving a receive terminal number; and a function of sending the SMS converted to the phonemic font information and the receive terminal number to an operating server for performing a SMS transfer service between the MSs using different kinds of languages.

In this case, the program can further include a function of selecting the receiving-country language.

The program can be mounted in the operating server and then downloaded to a user's MS upon request, as mentioned above, but can be previously mounted upon fabrication of a MS and then output. In this case, upon fabrication of the MS, a medium in which the program is downloaded functions as “the operating server” of the present invention. In the case of a MS in which the program is previously mounted and installed, the program download step can be omitted.

(4) Furthermore, the present invention relates to a method of receiving/confirming a SMS to transfer a SMS, written in a language other than a second language, from a transmit MS using a first language as a main language to a receive MS using the second language as a main language through a P2P network in which SMS nodes are independently connected on a country basis, the method including \textcircled{1} a message reception step, \textcircled{2} a foreign language character input program installation step and \textcircled{3} a message display step.

The message reception step is a step of transferring a text message written in a foreign language other than the second language to the receive MS through a common wired/wireless transmission path. In this step, in the case where a foreign language display function is included in the receive MS (including a case where the foreign language character input program of the present invention has already been installed), a SMS represented in the foreign language is displayed. If the foreign language display function is not included in the receive MS, (A) the foreign language character input program installation step is applied to the receive MS. That is, the operating server in which the language DB on a foreign language basis, the functions and the control program are stored for performing the method of the present invention is accessed, the language DB, the functions and the control program are downloaded and then installed at the receive MS. Of course, only a display-dedicated program except for a program part regarding the character input, of the foreign language character input program, can be installed, if needed.

This step can be performed only once except for update. Thus, when the foreign language character input program has already been installed at the receive MS (it can be installed upon MS fabrication or could had been installed when being used in the past), this step can be omitted. Thereafter, as the foreign language character input program operates, the foreign language SMS is displayed on the receive MS by utilizing Input Automata and a phonemic font with respect to the foreign language. Of course, information (codeset information, etc.) about a foreign language used can be added to the foreign language SMS.

(5) Furthermore, the present invention relates to a method of receiving/confirming a SMS to transfer a SMS, written in a language other than a second language, from a transmit MS using a first language as a main language to a receive MS using the second language as a main language through a P2P network in which SMS nodes are independently connected on a country basis, the method including \textcircled{1} a message information receiving step, \textcircled{2} an Internet access function determination step and \textcircled{3} a message display step.

The invention is performed as follows. The message information receiving step is a step of allowing the receive MS to receive information of [a guidance message+a message ID] form from the operating server in which a SMS is stored. In this case, the operating server receives at least [transmit MS information+message contents written in a language other than the second language+receive MS information] from the transmit MS, calculates an message ID, including an ID and/or a certification number as a certification function for confirming the message, and stores the calculated message ID. Thereafter, the operating server sends a guidance message, indicating that there is a message together with a message ID, to the transmit MS. The receive MS that has received information of [a guidance message+a message ID] form determines automatically or manually whether there is an Internet access function in the receive MS (the access function determination step). [symbol] If, as a result of the determination, there is the Internet access function, the receive MS accesses the operating server through the Internet, receives a message ID automatically/manually, certificates the SMS, and displays the stored SMS thereon. [symbol] If, as a result of the determination, there is no the Internet access function, the receive MS gains access to the operating server using a terminal (for instance, a PC allowing for Internet access), which allows for other Internet access, receives a message ID manually, certificates the SMS, and displays the stored SMS thereon (the message display step).

### ADVANTAGEOUS EFFECTS

According to the present invention, foreign language characters can be input conveniently without complicated infra. Thus, a SMS written in different foreign languages can be transmitted, allowing for a SMS between different kinds of languages.

### BRIEF DESCRIPTION OF THE DRAWINGS

FIG. 1 is a conceptual view of a hierarchical structure of a foreign language character input program according to the present invention.

FIG. 2 is a conceptual view of a system related to a global SMS transmission process by a method according to the present invention.

FIG. 3 is a flowchart illustrating the global SMS transmission process according to the present invention.

FIG. 4 is a flowchart illustrating a process of displaying a SMS by the method according to the present invention.

FIG. 5 is a flowchart illustrating a process of displaying a SMS written in a foreign language by another method according to the present invention.

### MODE FOR THE INVENTION

The present invention will now be described in detail with reference to the accompanying drawings.

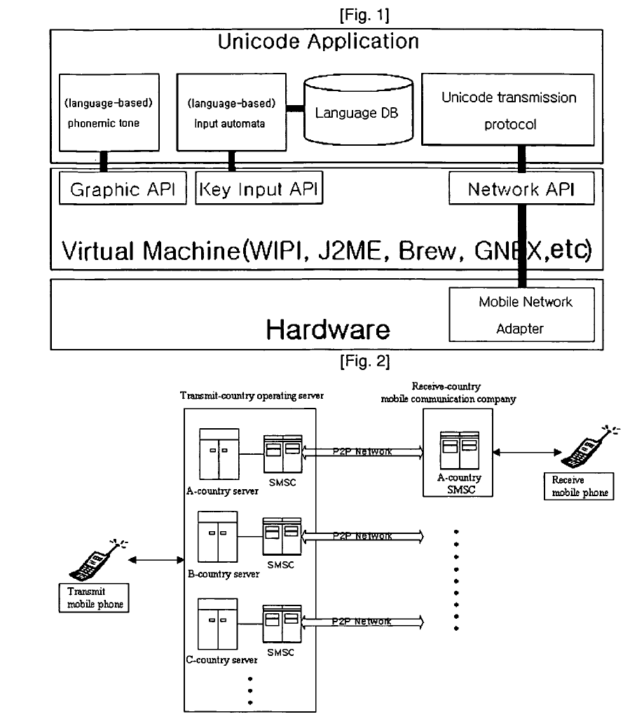

FIG. 1 is a conceptual view of a hierarchical structure in which a language DB on a foreign language basis, various APIs, and a unicode transmission protocol are represented in a mobile phone at which the foreign language character input program of the present invention is installed.

FIG. 2 is a conceptual view of a system related to a process of sending a SMS, written in an A-country language, to an A country and allowing the receive MS to receive a SMS written in the vernacular (an A-country language) by means of the method according to the present invention.

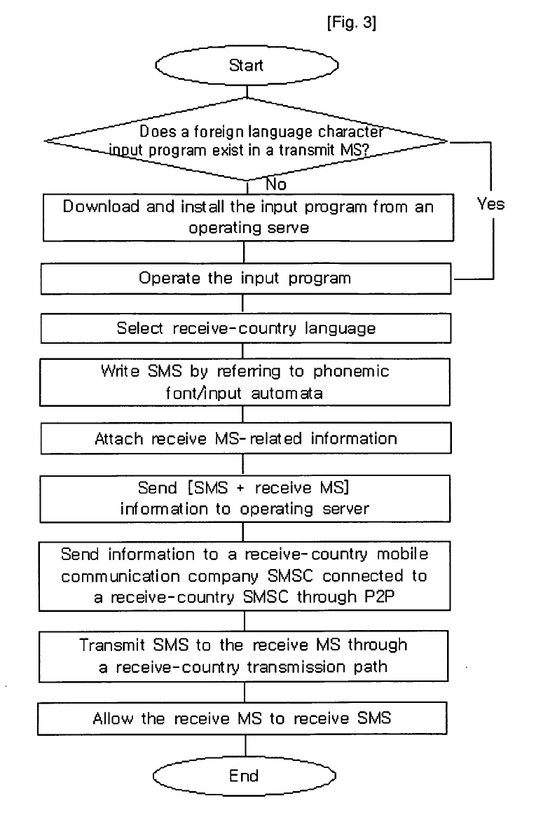

FIG. 3 is a flowchart illustrating a process of sending a SMS written in a foreign language and allowing the receive MS to receive a SMS written in the vernacular by means of the method according to the present invention.

FIG. 4 is a flowchart illustrating a process of sending a SMS written in a foreign language and allowing the receive MS to display the SMS written in the foreign language by means of the method according to the present invention.

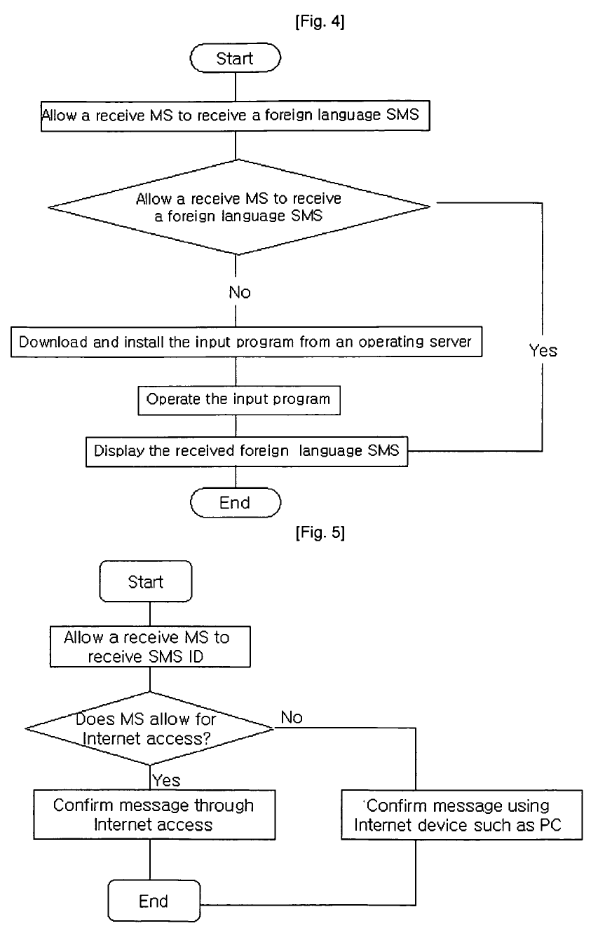

FIG. 5 is a flowchart illustrating a process of receiving a SMS written in a foreign language and displaying the SMS written in the foreign language on the receive MS, etc. by means of another method according to the present invention.

FIGS. 2 and 3 are described together. For convenience, the transmit MS will be referred to as a “transmit mobile phone” and the receive MS will be referred to as a “receive mobile phone”. It is assumed that a foreign language of a receive country is an A-country language. Furthermore, the operating server may be a collection of a plurality of servers related to the operation of the present invention as in FIG. 2, or may be one server having a program for controlling individual SMSCs connected to a plurality of countries through the P2P network.

A user first determines whether the foreign language character input program of the present invention has been installed at the transmit mobile phone. If, as a result of the determination, the foreign language character input program has not been installed at the transmit mobile phone, the user gains access to the operating server for operating the method of the present invention, downloads the foreign language character input program, and has it installed at the mobile phone. Thereafter, the user operates the foreign language character input program, and selects a foreign language (an A-country language) through which a SMS will be written. If a phonemic font with respect to the A-country language is displayed by the program after the foreign language is selected, the user writes a SMS written in the A-country language by referring to an A-country language Input Automata. If the writing of the SMS is completed, the user adds receive mobile phone-related information (including an A-country country code, etc.) and then “Send” the SMS. The foreign language character input program sends the information [the SMS+the receive mobile phone] to the operating server. The operating server decides a country where the language of the written SMS is used (that is, a country corresponding to country information included in the receive mobile phone information; the A country in FIG. 2) by referring to the information [the SMS+the receive mobile phone], and sends the information [the SMS+the receive mobile phone] to a mobile communication company SMSC of a receive country (the A country), which is connected to the A-country-dedicated server and -dedicated SMSC through P2P. The mobile communication company SMSC of the receive country sends the SMS to the receive mobile phone. Thus, the entire process is completed.

FIG. 4 is described. FIG. 4 is a process of displaying a SMS written in a foreign language on the receive MS by utilizing the program for SMS transfer between MSs with different languages according to the present invention. The receive MS first receive a SMS through a common path. It is then determined whether the received foreign language can be displayed. If, as a result of the determination, the received foreign language can be displayed, the SMS written in the foreign language is displayed. If, as a result of the determination, the received foreign language can not be displayed, the receive MS gains access to the operating server according to the present invention, and downloads and installs the foreign language character input program therein. The foreign language character input program operates and recognizes the foreign language, and displays the SMS written in the foreign language on the receive MS by referring to a font or Automata of a corresponding foreign language.

FIG. 5 is described. FIG. 5 is a process of displaying a SMS written in a foreign language on the receive MS or other terminals through the Internet by utilizing the program for SMS transfer between MSs using different kinds of languages according to the present invention. The receive MS first receives information of [a guidance message+a message ID] form from the operating server in which a SMS is stored, and then determines whether it has an Internet access function automatically/manually. [symbol] If, as a result of the determination, it has the Internet access function, the receive MS gains access to the operating server through the Internet and confirms a SMS. [symbol] If, as a result of the determination, it does not have the Internet access function, the receive MS gains access to the operating server by using other terminals having the Internet access and confirms a SMS.

In the present specification, description on examples of detailed phonemic fonts or methods of Input Automata with respect to each country's language has been omitted. It is, however, evident that the examples of phonemic fonts or the methods of Input Automata can be found in Korean Patent Application No. 10-2001-0053955 (entitled “Japanese Language Alphabet Input Apparatus”), 10-2001-0035167 (entitled “Hanguel Input Apparatus”), 10-2001-0020418 (entitled “Chinese Character Input System Utilizing Stroke”), 10-2001-0074376 (entitled “Method of Inputting Character to Digital Information Processing Apparatus”), 10-2001-0074377 (entitled “Method of Inputting Chinese Character to Digital Information Processing Apparatus and Digital Information Processing Apparatus”), 10-2001-0020417 (entitled “Hanguel Input System”), 10-2004-0035555 (entitled “Hanguel Input Apparatus”), 10-2002-0066454 (entitled “Alphabet Input Apparatus and Method Thereof”), 10-2002-0080531 (entitled “Method of Inputting Character to Digital Information Processing Apparatus”), 10-2003-0047461 (entitled “Digital Electronic Apparatus for Inputting Chinese Language Pnyn and Pnyn Input Method Thereof”), 10-2002-0013029 (entitled “Digital Information Processing Apparatus Capable of Inputting Japanese Language Alphabet”) and 10-2002-7007412 (entitled “Hanguel Input Apparatus”), all of which have been filed by the applicant of the present invention, or a variety of conventional character input apparatuses and methods.

### INDUSTRIAL APPLICABILITY

According to the present invention, the foreign language characters can be input conveniently by using mobile phones. Further, a SMS written in a foreign language can be sent to foreign countries through simple steps without complicated infra.

1. A method of transferring a Share Message System (SMS) between Mobile Stations (MSs) using different kinds of languages to transfer a SMS written in a foreign language from a transmit MS using a first language as a main language to a receive Mobil Station (MS) using a foreign language as a main language through a Peer to Peer (P2P) network in which SMS nodes on a country basis are independently connected, the method comprising:
a foreign language character input program installing step of gaining access to an operating server, downloading a language DB, functions and a control program on a foreign-language basis, and installing the language DB, the functions and the control program at the transmit MS, wherein when the program has already been installed at the transmit MS, this step can be omitted;
a message transmitting step of allowing the transmit MS to execute the foreign language character input program, select a foreign language to be input, input a message written in the selected foreign language, attach a receive MS number to the written text message, and send the written text message to the operating server:
a global transmitting step of allowing the operating server that has received the text message and the receive MS number to send the text message and the receive MS number to a receive country SMS center by referring to the receive MS number; and
a message receiving of transferring the text message to the receive MS through a wired/wireless transmission path.

2. The method of claim 1, wherein:
the language Data Base (DB) on a foreign-language basis includes Input Automata, a phonemic font and codeset information with respect to each foreign language, and
the functions and the control program include a key input API, a graphic API and a network API with respect to each foreign language.

3. A method of transferring a SMS between Mobile Stations (MSs) using different kinds of languages in a method of transferring a SMS written in a foreign language from a transmit MS using a first language as a main language to a receive MS using a second language as a main language through a P2P network in which SMS nodes on a country basis are independently connected, the method comprising:
a second language character input program installing step of accessing an operating server, downloading a language DB, functions and a control program with respect to the second language, and installing the language DB, the functions and the control program at the transmit MS, wherein when the program has already been installed at the transmit MS, this step can be omitted;
a message transmitting step of allowing the transmit MS to execute the second language character input program, input a message written in the second language, attach a receive MS number to the text message, and then send the text message to the operating server:
a global transmitting step of allowing the operating server that has received the text message and the receive MS number to send the text message and the receive MS number to a receive country SMS center by referring to the receive MS number;
a message receiving of transferring the text message to the receive MS through a wired/wireless transmission path.

4. The method of claim 3, wherein:
the language DB includes Input Automata, a phonemic font and codeset information with respect to the second language, and
the functions and the control program include a key input API, a graphic API and a network API with respect to the second language.

5. A computer-readable recording medium for Share Message Service (SMS) transfer between Mobile Stations (MSs) using different kinds of languages, wherein a program for implementing functions is recorded in the recording medium, the functions comprising:
a function of displaying Input Automata and a phonemic font with respect to a selected language and receiving a SMS written in a receiving-country language;
a function of converting the received SMS to phonemic font information of the receiving-country language;
a function of receiving a receive terminal number; and
a function of sending the SMS converted to the phonemic font information and the receive terminal number to an operating server for performing a SMS transfer service between the MSs using different kinds of languages.

6. The computer-readable recording medium of claim 5, further comprising a function of selecting a receiving-country language.

7. A method of receiving/representing a Share Message Service (SMS) written in a foreign language to transfer a SMS between MSs using different kinds of languages, the method comprising:
a message receiving step of allowing a receive MS to receive the SMS and confirm a language to represent the SMS;
a foreign language character input program installing step of, when there is no function to display a received foreign language, accessing an operating server in which a language DB, functions and a control program on a foreign-language basis are stored, downloading the language DB, the functions and the control program on a foreign-language basis, and installing the language DB, the functions and the control program at the receive MS; and
a message displaying of executing the foreign language character input program, and then displaying the foreign language SMS on the receive MS by referring to a language DB with respect to the foreign language.

8. The method of claim 7, wherein codeset information about the represented language is attached to the SMS written in the foreign language.

9. A method of receiving/representing a Share Message Service (SMS) written in a foreign language to transfer a SMS between Mobile Stations (MSs) using different kinds of languages, the method comprising:
a message information receiving of allowing a receive MS to receive information of [a guidance message+a message ID] form from an operating server in which the SMS is stored;
an access function determining of determining whether an Internet access function is included in the receive MS;
a message displaying, if it is determined that the Internet access function is included in the receive MS, accessing the operating server through an Internet, providing the message ID, and displaying a stored SMS on the receive MS; and
a message displaying, if it is determined that the Internet access function is not included in the receive MS, accessing the operating server by using another terminal that allows for Internet access, providing the message ID, and displaying a stored SMS on the receive MS.
